(19) United States
(12) Patent Application Publication
(10) Pub. No.: US 2010/0179849 A1
(43) Pub. Date: Jul. 15, 2010

(54) SYSTEM AND METHOD FOR IDENTIFYING BACKHAUL OPPORTUNITIES

(75) Inventors: Jonathan Steven Muckell, Albany, NY (US); Patricia Denise Mackenzie, Clifton Park, NY (US); Daniel John Messier, Albany, NY (US); Joseph James Salvo, Schenectady, NY (US); Qing Cao, Albany, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/568,699

(22) Filed: Sep. 29, 2009

Related U.S. Application Data
(60) Provisional application No. 61/143,508, filed on Jan. 9, 2009.

(51) Int. Cl. G06Q 10/00; G01S 5/00

(52) U.S. Cl. 705/8; 705/7; 342/357.07

(57) ABSTRACT

A method for identifying backhaul opportunities is provided. The method includes receiving data corresponding to a position, time and status from a plurality of vehicles. The method includes generating a database of trips made by the plurality of vehicles based on the data received, wherein each of the trips is identified with a start point and an end point. The method also includes determining similarity between the trips to cluster the trips, wherein said determining comprises comparing a spatial distance between respective start points and respective end points with a pre-determined distance criteria. The method further includes identifying a frequency of each of the trips clustered made by the plurality of vehicles, wherein each of the trips are actual routes traveled between respective start points and respective end points. The method also includes generating a model for historical vehicle movement based on the identified frequent trips. The method also includes identifying a plurality of backhaul opportunities for a proposed empty trip using the model generated. The method further includes ranking the backhaul opportunities based on a frequency and cargo status of trips intersecting the proposed empty trip.

### CROSS REFERENCE TO RELATED APPLICATIONS

The present patent application claims priority from provisional patent application Ser. No. 61/143,508, filed Jan. 9, 2009, the disclosure of which is hereby incorporated by reference in its entirety.

### BACKGROUND

The invention relates generally to intelligent transportation brokerage systems and more particularly, to backhaul analysis in transportation brokerage systems.

Recently, there has been an increasing interest in collaborative logistics in freight transportation industry. Typically, shippers and carriers have managed operations independently. A new trend emerging is to collaborate with other shippers and carriers, identify potential opportunities on a system level, and share benefit of integrated operation costs among partners.

In commercial transportation operations, one of the major wasteful expenditures is movement of vehicles or tractor-trailers with little or no cargo. Analysis of inter-fleet data shows many lost opportunities for identifying backhauling loads i.e. cargo that may have been moved by an otherwise empty trailer on a return trip from a delivery point to a home base.

Brokerage systems that facilitate matching of load sharing and backhaul opportunities currently do not incorporate monitoring of real-time, geo-based information, and analysis of geo-based information from all brokerage participants. Currently, transportation brokerage systems match loads to participating partners either through individual driver's use of kiosks located at various stops of vehicles, or other brokerage services. Lack of automation results in vehicles pulling empty/partial cargo despite a potential for collaborations.

Therefore, there is a need for an improved, automated brokerage system for identifying backhaul opportunities and address one or more aforementioned issues.

### BRIEF DESCRIPTION

In accordance with an embodiment of the invention, a method for identifying backhaul opportunities is provided. The method includes receiving data corresponding to a position, time and status from multiple vehicles. The method includes generating a database of trips made by the multiple vehicles based on the data received, wherein each of the trips is identified with a start point and an end point. The method also includes determining similarity between the trips to cluster the trips, wherein said determining comprises comparing a spatial distance between respective start points and respective end points with a pre-determined distance criteria. The method further includes identifying a frequency of each of the trips clustered made by the plurality of vehicles, wherein each of the trips are actual routes traveled between respective start points and respective end points. The method also includes generating a model for historical vehicle movement based on the identified frequent trips. The method also includes identifying multiple backhaul opportunities for a proposed empty trip using the model generated. The method further includes ranking the backhaul opportunities based on a frequency and cargo status of trips intersecting the proposed empty trip.

In accordance with another embodiment of the invention, a system for identifying backhaul opportunities is provided. The system includes a central data server to receive data corresponding to a position, time and status from multiple vehicles. The system also includes a processor configured to perform steps of generating a database of trips made by the multiple vehicles based on the data received, wherein each of the trips is identified with a start point and an end point. The processor is also configured to determine similarity between the trips to cluster the trips, wherein said determining comprises comparing a spatial distance between respective start points and respective end points with a pre-determined distance criteria. The processor is also configured to identify a frequency of each of the trips clustered made by the plurality of vehicles, wherein each of the trips are actual routes traveled between respective start points and respective end points. The processor is further configured to generate a model for historical vehicle movement based on the identified frequent trips. The processor is also configured to identify multiple backhaul opportunities for a proposed empty trip using the model generated. The processor is further configured to ranking the backhaul opportunities based on a frequency and cargo status of trips intersecting the proposed empty trip.

In accordance with another embodiment of the invention, a system for identifying backhaul opportunities is provided. The system includes multiple vehicle hubs that generate periodic status messages comprising location, time, cargo status and trigger event for a plurality of vehicles, each vehicle hub comprising a transmitter coupled electronically to the hub that broadcasts the status messages. The system also includes a central server configured to receive and store the status messages from the plurality of vehicle hubs in a telemetry database. The system further includes a trip extraction module configured to extract data from the telemetry database and generate a set of trips from the extracted data. The system also includes a characterization module configured to identify similar trips identified by the trip extraction module and to identify a frequency for each similar set of trips. The system further includes a backhaul matching module configured to match an empty trip of one of the vehicle hubs with one or more of the similar set of trips identified by the characterization module to identify a backhaul opportunity.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of a trailer system with a simplified communication system in accordance with an embodiment of the invention.

FIG. 2 is a schematic representation of exemplary trip segments made by multiple vehicles that enables generating a database of trips.

FIG. 3 is a supply chain network created based on trip clustering and the database of trips generated in FIG. 2.

FIG. 4 is a schematic illustration for calculating an actual route traveled by the vehicle in FIG. 1, in accordance with an embodiment of the invention.

FIG. 5 is a schematic representation of two exemplary intersecting routes that are clustered as frequent routes for a potential backhaul opportunity.

FIG. 6 is a schematic representation of exemplary historical pattern or network generated based on technique used to cluster frequent routes in FIG. 5.

FIG. 7 is a schematic representation of an exemplary empty trip from Virginia/North Carolina border in order to identify a backhaul opportunity in accordance with an embodiment of the invention.

FIG. 8 is a flow chart representing steps in a method for identifying backhaul opportunities in accordance with an embodiment of the invention.

### DETAILED DESCRIPTION

As discussed in detail below, embodiments of the invention include a system and method for identifying backhaul opportunities. The system and method provide an algorithm for near real time detection of backhaul opportunities in collaborative transportation systems, thereby reducing wasteful transportation behavior. There are two types of collaborative transportation systems. One is a centralized, on-demand transportation management system that includes commercial service providers. The other is a decentralized, online brokerage system that provides a marketplace for private transportation participants, to exchange information, respond to demand and supply fluctuations, and optimize operation costs.

In order to enable near real-time detection of backhaul opportunities, historical data obtained from a large-scale asset-tracking telematics system spanning an entire continent (North American) has been analyzed. Firstly, the technique identifies frequent trip routes from the telematics dataset in order to determine patterns in vehicle or freight movement. The technique further identifies backhaul opportunities based on frequency of trip routes that overlap, and status of cargo for respective routes.

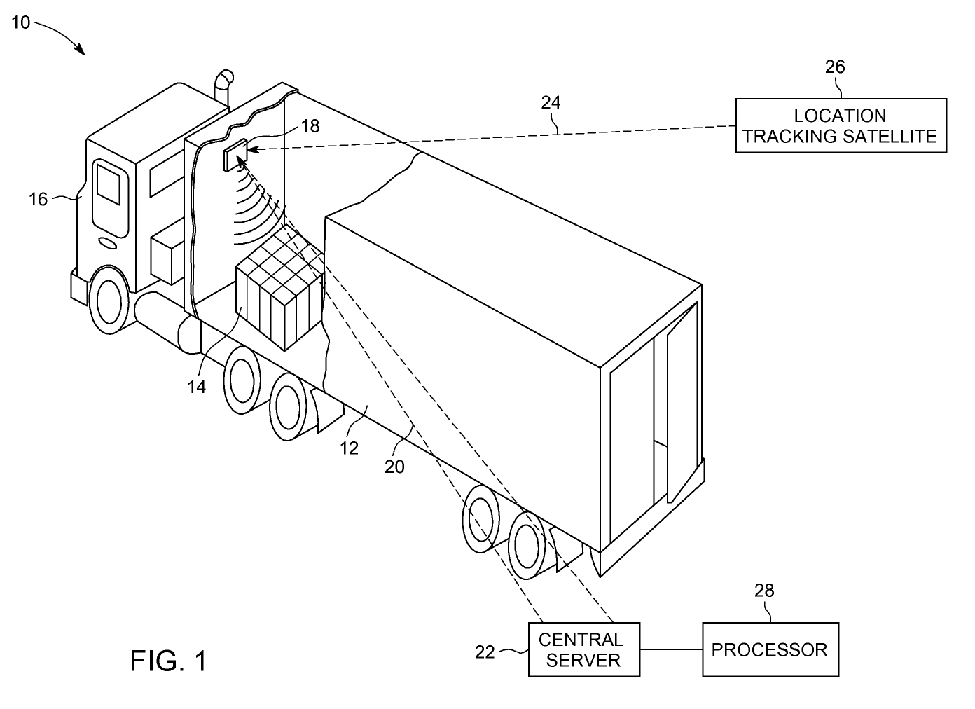

FIG. 1 is a schematic illustration of a trailer system 10 with a simplified communication system. The system 10 includes a trailer 12 carrying goods 14 and a cab 16 attached to a front end of the trailer 12 having a driver. Although the illustrated embodiment shows a trailer, other types of vehicles may be employed. A remote hub 18 is located in the trailer 12. The remote hub 18 is configured to transmit wireless signals 20 to a central server 22. The remote hub 18 may also receive wireless signals 24 about location information via a location tracking satellite 26. Non-limiting examples of transmitting the wireless signals 20 include cellular, satellite or WiFi communication. A non-limiting example of a location tracking satellite 26 may include a global positioning satellite (GPS). In another embodiment, the location information may be provided by a non-satellite source. The remote hub 18 further transmits wireless signals to the cab 16 to relay information received via the wireless signals 20 and 24 respectively. One example of such a remote hub 18 is a VeriWise™ hub, produced by the General Electric Company. The central server 22 is coupled to a processor 28 configured to identify backhaul opportunities.

It should be noted that embodiments of the invention are not limited to any particular processor for performing the processing tasks of the invention. The term “processor,” as that term is used herein, is intended to denote any machine capable of performing the calculations, or computations, necessary to perform the tasks of the invention. The term “processor” is intended to denote any machine that is capable of accepting a structured input and of processing the input in accordance with prescribed rules to produce an output. It should also be noted that the phrase “configured to” as used herein means that the processor is equipped with a combination of hardware and software for performing, the tasks of the invention, as will be understood by those skilled in the art.

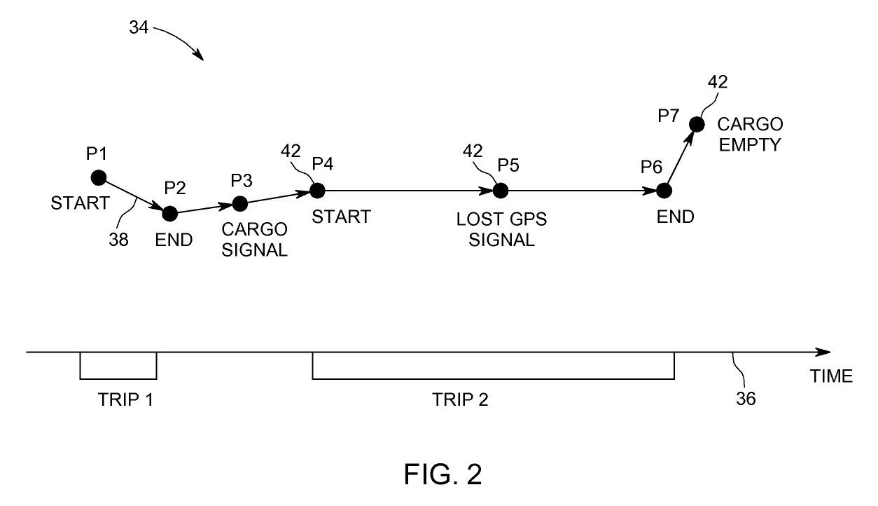

FIG. 2 is a schematic representation of exemplary trip segments 34 made by multiple vehicles 12 (FIG. 1) over a period of time 36 that enable generating a database of trips. Initially, data corresponding to a position, time and status from the hub 18 (FIG. 1) is received. A typical message is defined as:

P={lat,lon,t,e} (1),

wherein lat is latitude, lon is longitude, t is timestamp and e is an event code or status. Non-limiting examples of an event code are ‘trip start’, ‘trip end’, ‘door open’, ‘door close’, ‘cargo loaded’, ‘cargo empty’, ‘lost GPS signal’, and ‘low battery’. In operation, a remote hub 18 sends a ‘trip start’ event message when the vehicle 12 starts a trip and a ‘trip end’ event when the vehicle stops moving, as referenced by numeral 38. Data points correspond to a specific latitude and longitude. In order to generate or extract trips made by vehicles 12, the trips are represented by message sequences between consecutive ‘trip start’ events and ‘trip end’ events, as referenced by numeral 42. Hence, a trip T may be defined as:

T={Pᵢ,(Pᵢ₊₁, . . . ),Pⱼ} (2)

wherein Pᵢ and Pⱼ are consecutive ‘trip start’ events and ‘trip end’ events respectively, and (Pᵢ₊₁, . . . ) are possible intermediate non-trip-related event messages. Intermediate messages are critical in differentiating trips. Given the sparse nature of some telematics data, most of the trip data will have only start and end points, with no information about which route the asset takes on the trip. Locations of the intermediate messages provide additional information about a trip and can be useful to differentiate trips with different routes.

Due to the noisy nature of telematics data, heuristics rules can be added to the trip extraction process. In an ideal scenario, a ‘trip start’ message and a corresponding ‘trip end’ message appear in pairs, thus defining a trip. However, in practice, ‘trip start’ or ‘trip end’ messages may mismatch. For example, a ‘trip start’ message may be followed by another ‘trip start’ message, or a ‘trip end’ message may not have a corresponding ‘trip start’ message. In another embodiment, there may be multiple ‘trip start’ and ‘trip end’ messages missing. This can be inferred by checking if time duration between a ‘trip start’ and ‘trip end’ message exceeds a certain time threshold, say 3 days. In yet another embodiment, a ‘trip start’ message and a corresponding ‘trip end’ message are sent from the same location. This usually occurs when a vehicle has traversed a short distance roundtrip. The trip extraction algorithm based on the above heuristic rules will sequentially process the GPS data stream, looking for consecutive “trip start” and “trip end” message pairs. The duration and distance between the consecutive “trip start” and “trip end” message pairs are calculated to filter out exceptional cases.

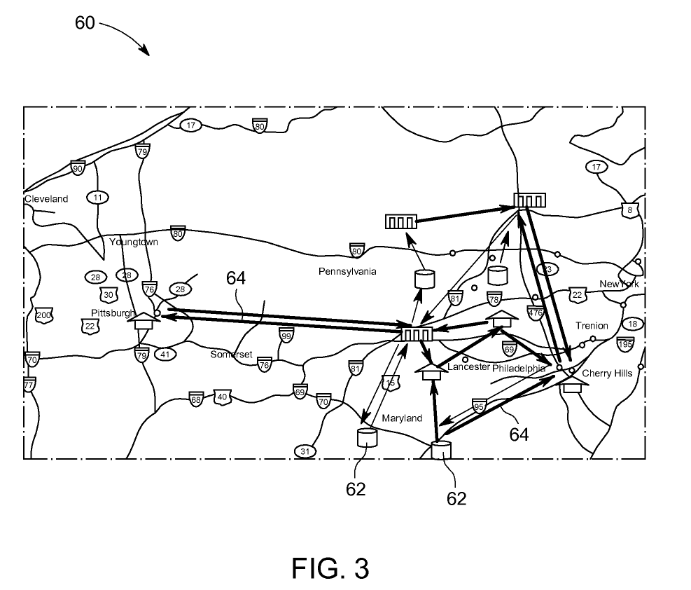

FIG. 3 is a supply chain network 60 created based on trip clustering. Given that a large database of trips are generated, it is difficult to visually explore patterns in the trips and hence, ‘similar’ trips are determined to cluster the trips. This makes it convenient for a user to segregate or classify the trips. As used herein, the term ‘similar trips’ refers to trips that have their respective start and end locations spatially close. Different global positioning coordinates may refer to a same location.

In one embodiment, point 1 (42.3463, −71.0974), point 2 (42.3464, −71.0975), and point 3 (42.3460, −71.0976) all refer to the same location i.e. “Fenway park” in Boston, Mass. It should be noted that the coordinates are equivalent to a latitude and longitude of a particular location. Therefore, to determine if a start and end locations of two trips are spatially similar, a small radius d is used to address the fuzziness of locations represented by global positioning coordinates. The radius d may also be referred to as a predetermined distance. Nodes 62 represent significant locations such as, but not limited to, distribution centers, stores, vendors, and maintenance facilities. Links 64 are frequent trips going between these nodes and a thickness of each of the link 64 indicates frequency of the trips, wherein greater the thickness, higher is the frequency.

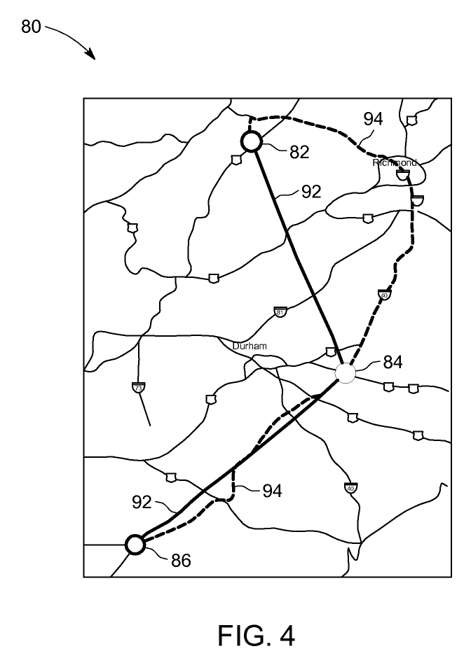

FIG. 4 is a schematic illustration 80 for calculating an actual route traveled by the vehicle 12 (FIG. 1). Frequent trip data generated from FIG. 3 exists as a series of line segments connecting different time based, geo-referenced messages received from a device such as, a remote hub 18 (FIG. 1). An ordered series of three geo-coded messages received corresponding to three locations denoted by reference numerals 82, 84, 86 respectively is observed. A straight-line distance between the three locations is denoted by 92, while an estimated route between the three locations is denoted by 94. In practice, the straight-line distance 92 between locations 82 and 84 is known to be very inaccurate since there are no major highways within a reasonable distance of the line 92. Restriction of large vehicles, such as, but not limited to, trucks, to major roadways further reduces domain of possible routes traveled. The line 94 is a likely estimation of the actual route.

To calculate the actual route, a geometric network is constructed using software that allows for calculating routes and modeling the historical flow of monitored resources throughout a roadway network. In an exemplary embodiment, an ArcGIS software is employed. ArcGIS software is commercially available and well-known in the art. More details of the software may be obtained in internet website www.esri.com. Edges are weighted based on the cost or estimated travel-time to traverse each edge. The route with the minimal traversal time is often, but not always, considered the most likely traversed route. Additional information determined from analysis of telematics data can help validate the accuracy of the predicted route. The reasonableness of a proposed route is determined by comparing the estimated travel time to the actually observed duration. In another embodiment, to further improve accuracy, intermediate messages are analyzed. These are event-based messages beyond start/end of trip information, such as “door open”, or “cargo loaded.” Since each frequent trip is comprised of a set of individual trips, the in-transit messages from each trip assists in determining the frequently traversed routes. The frequent routes thus derived are used to create a model of historical freight movement.

In order to generate a model for historical vehicle movement, variables need to be associated with appropriate geographical locations and routes. Exemplary variables include cargo status and frequency information. It should be noted that other variables related to temporal information such as, extent of time collaboration or load sharing that may occur, also may be employed. Furthermore, location of distribution centers where trucks may be physically loaded and unloaded may be critical. As used herein, cargo status is defined as the ratio of full trips to total trips, and is recorded as a Boolean, specifically, 1=cargo_status, 0=no cargo_status. A value of 0 indicates that vehicles that traveled along that route were empty. Similarly, if cargo_status=1, then all the vehicles traveled full. A mean cargo_status of 0.5 would indicate half of the vehicles traveling that route as empty and half were full. Knowledge of cargo status is crucial in assessing backhaul opportunities i.e. matching between empty trips and full trips occurring in the same direction. A similar process occurs for route frequency, except that the frequency for each route is initialized based on number of trips clustered together. The frequency of these trips weights a backhaul opportunity in determining likelihood that a collaborative match may occur within temporal restraints. In the model, each road segment is embedded with cargo status and frequency information for each direction of travel. To determine cargo status and frequency at specific route segments, routes that overlap need to be combined.

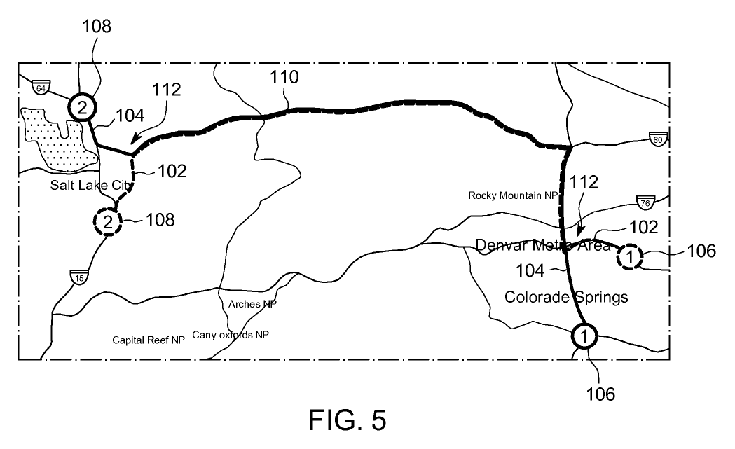

FIG. 5 is a schematic representation of two exemplary intersecting routes that are clustered as frequent routes for a potential backhaul opportunity, with one depicting a trip hauling cargo referenced by numeral 102 and another depicting an empty trip, referenced by numeral 104. The start points and end points for respective trips are designated as 106 and 108 respectively. An overlap portion 110 exists between the two routes. At the intersection 112, average cargo_status is 50%, i.e. 50% of the vehicles moving along the intersection have cargo. Since two routes overlap and frequency of the intersection equals summation of the two frequencies, the frequency for the westward direction of the intersection is equal to 2.

To determine cargo status and frequency features, a roadway network is segmented based on overlap and direction of travel. The frequency and cargo status is calculated for all road segments. A route segmentation algorithm creates a new route R_{new} (110) which is defined by intersection of the route 102, denoted by R₁ and route 104, denoted by R₂:

R_{new}=R₁∩R₂ (3)

Three routes are created from the two original routes 102 and 104 to distinguish between the three different segments R_{new}, R₁, and R₂. The three segments 102, 104, and 110 respectively are: (1) where R₁ and R₂ intersect, frequency is two and cargo status is one-half; (2) disjoint set of R₁ and R_{new}, this defines section of R₁ where R₁ and R_{new} do not overlap. In this case, frequency is one and cargo status is one and (3) the disjoint set of R₂ and R_{new}, with frequency is one and cargo status is zero.

The different states that exist between the intersecting and non-intersecting segments require dividing two routes into three when a non-empty intersection occurs. Such segmentation is performed for every route in the domain. For each intersection 112, variables are determined at the corresponding geographic location. Examples of these variables include frequency and cargo status at each location along the roadway network. Initially, each frequent route has a variable frequency that is initialized by the number of trips that were clustered into that frequent route. An additional variable cargo_status is initialized to the ratio of full to empty trips for each direction along the road network. FIG. 5 depicts a common scenario when two routes overlap. In the overlapping regions the geo-specific variables need to be modified. In the exemplary illustration, the portion from Denver to Salt Lake City intersects and therefore the variables along the route of the two cities need to be changed. Specifically, at the intersection of the two routes the frequency equals the summation to the two frequencies and the cargo status equals the weighted average of the combined cargo status variables.

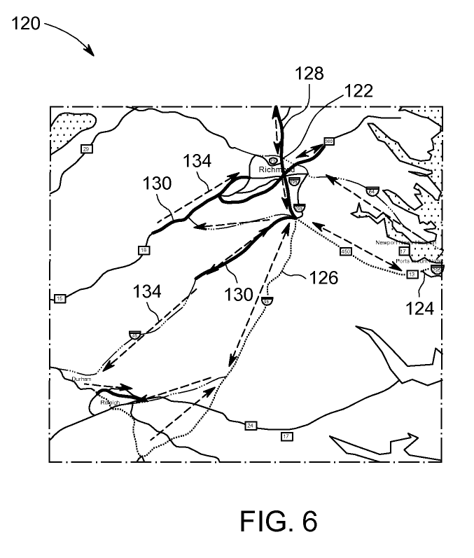

FIG. 6 is a schematic representation of exemplary historical pattern or network 120 generated based on the algorithm above. Routes 122, 124, 126, 128, and 130 represent routes with increasing frequency. Arrows 134 represent direction of travel. The illustration defines historical movement of freight, essential in predicting backhaul opportunities. The historical network 120 is updated constantly as additional telematics information is collected.

In order to detect backhaul opportunities, the historical network 120 is queried based on a proposed empty trip. Two inputs are required for determining backhaul collaboration opportunities: accurate determination of historical vehicle or freight movement patterns and current intentions of a distributor. In an example, consider a situation in which a driver has just delivered a shipment to a Virginia/North Carolina border. A driver now needs to return towards a distribution center outside the Richmond metropolitan area. The cost of fuel, driver's pay and vehicle overhead make it expensive to drive a long distance without pulling any revenue generating cargo. A backhaul opportunity exists if the empty trip intersects with a frequently traveled route. Such potential intersections are identified based on the historical vehicle movement patterns, as described above, (FIG. 5) and the driver's current intentions.

At the intersection, likelihood of collaboration is determined based on frequency of the route and percentage of full cargo loads on the route, also defined as cargo status. The higher the frequency, the more likely backhaul collaborations may occur within time restrictions, since waiting for potential loads is often expensive. Additionally, a high percentage of full loads or cargo status is an indicator of a greater demand for hauling goods into a particular region. Furthermore, basic economic theory states that higher demand results in higher prices. Therefore, high demand for freight transportation in the same desired direction should result in substantial payoff and therefore increase motivation for collaboration.

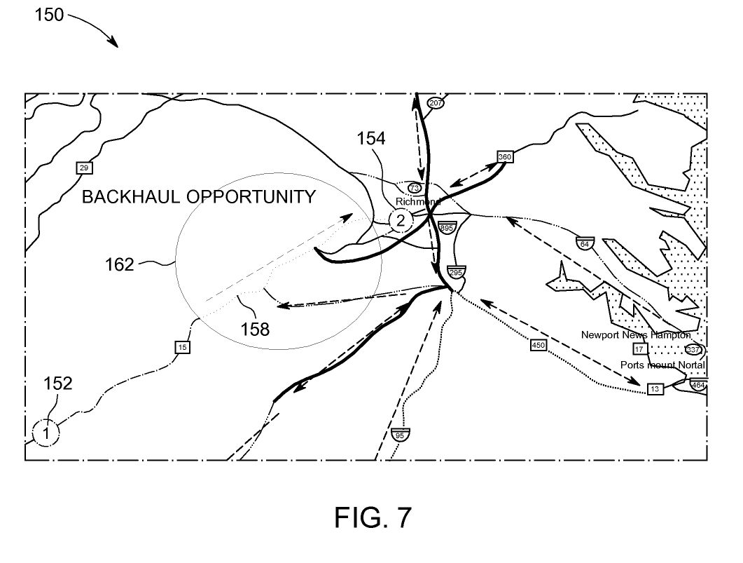

FIG. 7 is a schematic representation of an exemplary empty trip 150 from Virginia/North Carolina border represented by reference numeral 152 towards Richmond, 154 in order to identify a backhaul opportunity. The trip 152 indicates a vehicle returning to a distribution center after delivering a primary shipment. The trip overlaps with a highly traveled route in the same direction about halfway towards Richmond, as indicated by reference numeral 158. Since both the frequency of trips and percentage of full loads are high, there is a very significant opportunity to collaborate on backhaul. Region 162 indicates where collaboration could occur. The viability of the opportunity is determined by frequency and average cargo status at the intersection of the empty trip and the historical freight model. All the potential backhaul opportunities identified are ranked. An algorithm for detecting backhaul is as below:

If Historical_network∩Empty trip=Φ, then

Print “No viable opportunity”

Else

RANK=frequency*cargostatus

End (4)

Thus, the backhaul opportunities are ranked as per above criterion. If the empty trip does not intersect with a frequently traveled route, then historical trends indicate that it is more difficult to collaborate on backhaul. In such cases, visual inspection of historical vehicle movement patterns may assist a fleet manager in identifying cost-saving behavioral changes. The changes may include deviations from shortest route to allow for collaboration to occur. A product of frequency and cargo status determines a ranking of viability of the backhaul opportunity. In a particular embodiment, external variables that impact backhaul collaborations also referred to as risk factors may be considered. Some non-limiting examples of the risk factors include travel time and network constraints. In an example, a high variance in travel time correlates to higher risk. In another example, avoiding traveling in a certain area due to environmental or safety constraints correlates to higher risk.

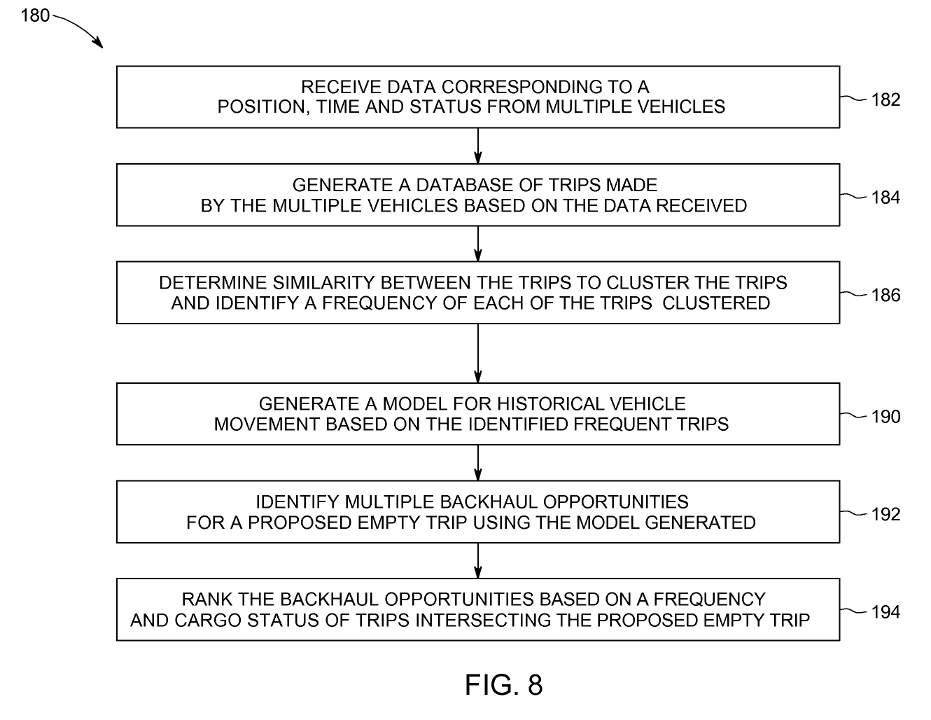

FIG. 8 is a flow chart representing steps in a method 180 for identifying backhaul opportunities. The method 180 includes receiving data corresponding to a position, time and status from multiple vehicles in step 182. A database of trips made by the multiple vehicles is generated based on the data received in step 184. Each of the trips is identified with a start point and an end point. A similarity between the trips is determined in order to cluster the trips and a frequency of each of the trips clustered is identified in step 186. In one embodiment, it is determined if a spatial distance between respective start points and end points are below a pre-determined distance criterion. Each of the trips are actual routes traveled between respective start points and respective end points. In an exemplary embodiment, actual routes are determined by constructing a geometric network employing ArcGIS software. A model for historical vehicle movement is generated based on the identified frequent trips in step 190. Multiple backhaul opportunities are identified for a proposed empty trip based on the model generated in step 192. The backhaul opportunities are ranked based on a frequency and cargo status of trips intersecting the proposed empty trip in step 194. In a particular embodiment, future cargo is assigned on intersecting trips based on the ranking in order to execute the backhaul opportunities. In another embodiment, one or more risk factors are assessed. Some non-limiting examples of the risk factors include travel time on frequently traveled routes due to traffic and network constraints.

The various embodiments of system and method to identify backhaul opportunities described above thus provide near real-time automated detection by using a large telematics network tracking hundreds of thousands of assets. The system and method facilitate automated business partner discovery and multi-hop schedule recommendations. The technique also benefits larger fleets and improves freight transit efficiency, thus reducing number of vehicles traveling with empty cargo. This further reduces amount of CO₂ and NOx emissions produced by the vehicles. By identifying backhaul collaborative opportunities, a number of empty miles can be reduced, saving money on fuel, salary and vehicle costs and reducing emissions.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of a GPS to receive position data with respect to one embodiment can be adapted for use with a processor configured to assess one or more risk factors described with respect to another. Similarly, the various features described, as well as other known equivalents for each feature, can be mixed and matched by one of ordinary skill in this art to construct additional systems and techniques in accordance with principles of this disclosure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A method for identifying backhaul opportunities, the method comprising:
receiving data corresponding to a position, time and status from a plurality of vehicles;
generating a database of trips made by the plurality of vehicles based on the data received, wherein each of the trips is identified with a start point and an end point;
determining similarity between the trips to cluster the trips, wherein said determining comprises comparing a spatial distance between respective start points and respective end points with a pre-determined distance criterion;
identifying a frequency of each of the trips clustered made by the plurality of vehicles, wherein each of the trips are actual routes traveled between respective start points and respective end points;
generating a model for historical vehicle movement based on the identified frequent trips;
identifying a plurality of backhaul opportunities for a proposed empty trip using the model generated; and
ranking the backhaul opportunities based on a frequency and cargo status of trips intersecting the proposed empty trip.

2. The method of claim 1, comprising assigning future cargo on intersecting trips based on the ranking in order to execute the backhaul opportunities.

3. The method of claim 1, comprising assessing one or more risk factors associated with identifying backhaul opportunities.

4. The method of claim 3, wherein assessing one or more risk factor comprises computing a variation in travel time due to traffic.

5. The method of claim 3, wherein assessing one or more risk factor comprises assessing network constraints.

6. The method of claim 1, wherein said receiving comprises receiving via a GPS receiver.

7. The method of claim 1, wherein said identifying the frequency comprises determining actual routes by constructing a geometeric network employing ArcGIS software.

8. The method of claim 1, wherein said determining similarity between the trips comprises determining if a spatial distance between respective start points and end points of two trips are below a pre-determined distance.

9. A system for identifying backhaul opportunities comprising:
a central data server to receive data corresponding to a position, time and status from a plurality of vehicles; and
a processor configured to perform steps of:
generating a database of trips made by the plurality of vehicles based on the data received, wherein each of the trips is identified with a start point and an end point;
determining similarity between the trips to cluster the trips, wherein said determining comprises comparing a spatial distance between respective start points and respective end points with a pre-determined distance criteria;
identifying a frequency of each of the trips clustered made by the plurality of vehicles, wherein each of the trips are actual routes traveled between respective start points and respective end points;
generating a model for historical vehicle movement based on the identified frequent trips;
identifying a plurality of backhaul opportunities for a proposed empty trip using the model generated; and
ranking the backhaul opportunities based on a frequency and cargo status of trips intersecting the proposed empty trip.

10. The system of claim 9, wherein said status message comprises at least one of a message signifying start or end of a trip or an intermediate message.

11. The system, of claim 9, wherein said status message comprises a ‘trip start’ or a ‘trip end’ message.

12. The system of claim 9, wherein said intermediate message comprises a ‘door open’, a ‘door closed’, ‘cargo loaded’, or a ‘cargo empty’ message.

13. The system of claim 9, wherein said data is received via a GPS receiver.

14. The system of claim 9, wherein said processor is configured to assign future cargo on intersecting trips based on the ranking in order to execute the backhaul opportunities.

15. The system of claim 9, wherein said processor is configured to assess one or more risk factors associated with identification of backhaul opportunities.

16. The system of claim 9, wherein said vehicles comprise a truck or a tractor-trailer.

17. A system for identifying backhaul opportunities comprising:
a plurality of vehicle hubs that generate periodic status messages comprising location, time, cargo status and trigger event for a plurality of vehicles, each vehicle hub comprising a transmitter coupled electronically to the hub that broadcasts the status messages;
a central server configured to receive and store the status messages from the plurality of vehicle hubs in a telemetry database;
a trip extraction module configured to extract data from the telemetry database and generate a set of trips from the extracted data;
a characterization module configured to identify similar trips identified by the trip extraction module and to identify a frequency for each similar set of trips; and
a backhaul matching module configured to match an empty trip of one of the vehicle hubs with one or more of the similar set of trips identified by the characterization module to identify a backhaul opportunity.
